(19) United States
(12) Patent Application Publication
(10) Pub. No.: US 2017/0316643 A1
(43) Pub. Date: Nov. 2, 2017

(54) TABLETS FOR AUGMENTING SERVICES OF ELECTRONIC TERMINALS AND ELECTRONIC GAMING MACHINES (EGMs) AND METHODS OF USING THEREOF

(71) Applicant: Intralot S.A. - Integrated Lottery Systems and Services, Athens (GR)

(72) Inventors: George Plakas, Athens (GR); Apostolos Dalas, Athens (GR)

(21) Appl. No.: 15/521,411

(22) PCT Filed: Oct. 26, 2015
(86) PCT No.: PCT/IB2015/002149

§ 371 Date: Apr. 24, 2017

Related U.S. Application Data
(60) Provisional application No. 62/068,222, filed on Oct. 24, 2014.

(51) Int. Cl. G07F 17/32

(52) U.S. Cl. CPC G07F 17/3225; G07F 17/3216; G07F 17/3223

(57) ABSTRACT

In some embodiments, the present invention provides for a method, including: providing a first component including a first game-operating device, operationally interconnecting the first component to a second component to form a second game-operating device; where the first game-operating device is a stand-alone operating device, and where the second component is a dedicated auxiliary device, delivering from the second component at least one auxiliary service which has not been previously provided by the first component, where the at least one auxiliary service selected from the group including: a card reading service, an online connection service, a responsible gaming service, a player tracking and loyalty service, a multimedia service, a side game service, a user identification service, and an identity protection service.

### RELATED APPLICATIONS

This application claims the priority of U.S. provisional application Ser. No. 62/068,222, entitled “TABLETS FOR AUGMENTING SERVICES OF ELECTRONIC TERMINALS AND ELECTRONIC GAMING MACHINES (EGMs) AND METHODS OF USING THEREOF,” filed Oct. 24, 2014, which is incorporated herein by reference in its entirety for all purposes.

### FIELD OF INVENTION

The instant invention is related to computer methods and systems to augment services of electronic terminals and electronic gaming machines.

### BACKGROUND OF INVENTION

A lottery is a form of gambling which involves the drawing of lots for a prize.

### BRIEF SUMMARY OF INVENTION

In some embodiments, the present invention provides for a method, including: providing a first component comprising a first game-operating device, operationally interconnecting the first component to a second component to form a second game-operating device; where the first game-operating device is a stand-alone operating device, and where the second component is a dedicated auxiliary device, delivering from the second component at least one auxiliary service which has not been previously provided by the first component, where the at least one auxiliary service selected from the group including: a card reading service, an online connection service, a responsible gaming service, a player tracking and loyalty service, a multimedia service, a side game service, a user identification service, and an identity protection service. In some embodiments, the dedicated auxiliary device is affixed to the first game-operating device. In some embodiments, the dedicated auxiliary device is affixed to the first game-operating device in a vertical orientation. In some embodiments, the dedicated auxiliary device is affixed to the first game-operating device in a horizontal orientation.

In some embodiments, the present invention provides for a device, including: a first component, where the first component previously existed as a first game-operating device which has not been previously provided at least one auxiliary service selected from the group including: a card reading service, an online connection service, a responsible gaming service, a player tracking and loyalty service, a multimedia service, a side game service, a user identification service, and an identity protection service; where the first game-operating device is a stand-alone operating device, a second component which is a dedicated auxiliary device configured to provide the at least one auxiliary service in conjunction with the first game-operating device; and where the dedicated auxiliary device is operationally interconnected with the first game-operating device. In some embodiments, the dedicated auxiliary device is affixed to the first game-operating device. In some embodiments, the dedicated auxiliary device is affixed to the first game-operating device in a vertical orientation. In some embodiments, the dedicated auxiliary device is affixed to the first game-operating device in a horizontal orientation.

### BRIEF DESCRIPTION OF THE DRAWINGS

The present invention will be further explained with reference to the attached drawings, wherein like structures are referred to by like numerals throughout the several views. The drawings shown are not necessarily to scale, with emphasis instead generally being placed upon illustrating the principles of the present invention. Further, some features may be exaggerated to show details of particular components.

The figures constitute a part of this specification and include illustrative embodiments of the present invention and illustrate various objects and features thereof. Further, the figures are not necessarily to scale, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

FIG. 1 illustrates some embodiments of the inventive system of the present invention, showing network servers communicating with client devices by use of a network.

FIG. 2 illustrates some embodiments of the inventive system of the present invention, showing a computer and network architecture that supports the inventive system.

FIG. 3 illustrates some embodiments of the inventive system of the present invention, showing a cloud system supporting the inventive system.

FIG. 4 illustrates some embodiments of the inventive system of the present invention, showing the cloud systems supporting the inventive system and allowing a delivering and receiving of information to and/or from cloud clients.

FIG. 5 illustrates some embodiments of the inventive system of the present invention, showing a tablet stationed next to an electronic gaming machine.

In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

### DESCRIPTION

Among those benefits and improvements that have been disclosed, other objects and advantages of this invention will become apparent from the following description taken in conjunction with the accompanying figures. Detailed embodiments of the present invention are disclosed herein; however, it is to be understood that the disclosed embodiments are merely illustrative of the invention that may be embodied in various forms. In addition, each of the examples given in connection with the various embodiments of the invention which are intended to be illustrative, and not restrictive.

Throughout the specification and claims, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, “stand-alone” refers to a device that previously existed. For example, a stand-alone device can be an outdated device, where the outdated device is, for example, not programmed to deliver recent programs, activities, etc.

In some embodiments, each inventive electronic terminal can be any purpose terminal that transacts with individuals (e.g., a lottery terminal, a gaming terminal, a vending machine, an individual's mobile device being programmed to serve, as, for example, lottery and/or gaming terminal, etc.).

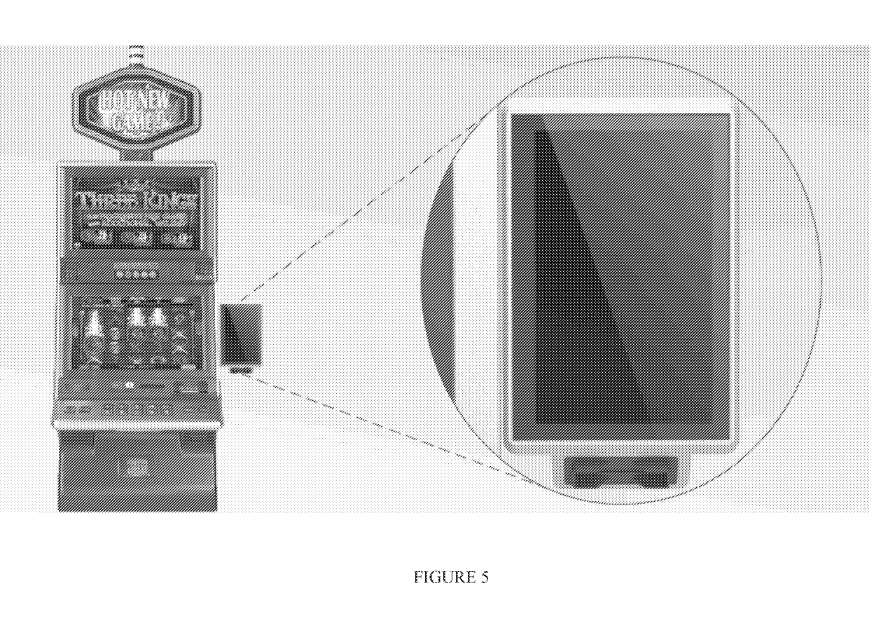

In some embodiments, the inventive system(s) of the present invention can include providing additional services to a user through an electronic machine (e.g., an electronic terminal, a vending terminal, an electronic gaming machine (“EGM”), etc.), where an exemplary EGM can be a secured terminal (e.g., but not limited to, a logic terminal, a video gaming machine). In some embodiments, the inventive system(s) of the present invention can include providing additional services to a user that otherwise would not be available to a user, where the additional services can be delivered to the user by fixing (i.e., securing and/or mounting) an exemplary inventive auxiliary smart electronic device (e.g., tablet) onto the electronic machine (i.e., the electronic terminal, EGM, etc.). In some embodiments, the additional service(s) can include, but are not limited to, an online connection to an internet and/or an intranet, communication with a third party (e.g., but not limited to, restaurants, movie theaters, airline companies, hotels, car rental agencies), central monitoring systems, or any combination thereof. In some embodiments, the additional services can include, but are not limited to, responsible gaming (e.g., assistance and/or recognition of gaming addiction), user/player tracking and loyalty (i.e., whether a user is a frequent user, whether a user is a new user or infrequent user and may be eligible to receive incentives, e.g., free games, discounted services, etc.), multimedia and/or value added services, side games, or any combination thereof. FIG. 5 illustrates an embodiment of the inventive system of the present invention, showing an exemplary inventive auxiliary smart electronic device (e.g., tablet) affixed to an EGM and configured to provide additional services to the user.

In some embodiments, the inventive system(s) of the present invention can be configured to receive/identify/read/verify information provided by a possible user, where the information can be received by an exemplary inventive auxiliary electronic device (e.g., a tablet) configured to receive information from a card reader and/or include card reading capabilities (e.g., the card reader module can be part of the tablet), where the exemplary inventive auxiliary electronic device can be configured to allow a user to input information using, e.g., a personal player card (i.e., a card specific to the user that can be configured to initiate, terminate, and/or select an account and/or at least one game), where the inventive system (once the user's identification is verified) can initiate the delivery of any additional services to the user as detailed above. In some embodiments, the personal player card and/or the exemplary inventive auxiliary electronic device is/are configured to utilize magnetic, “smart”, RFID/contactless (i.e., near-field wireless communication, “NFC”), or any combination thereof, technology(ies) to provide service(s) (i.e., activate, terminate, select, etc. a game and/or additional service) to a user.

In some embodiments, the inventive system(s) of the present invention(s) can be configured to use a contactless method (e.g., a RFID/NFC reader), where the contactless method (i.e., additional service/capability) can be provided by the exemplary inventive auxiliary electronic device (e.g., tablet). In some embodiments, the inventive system(s) including an EGM and an exemplary inventive auxiliary electronic device (e.g., tablet) is/are configured to include the card reading module/capability(ies), and where the exemplary inventive auxiliary electronic device can be configured to include the card reading module/capability(ies). In some embodiments, the inventive system(s) is/are configured to receive information from an external card reader(s)/module configured to identify/read cards. In some embodiments, the inventive system can be configured to permit a user to enter/“log in” to an account (e.g., a personal account) within a sufficient proximity of the EGM (e.g., 0.5 feet, 1 foot, 2 feet, 3 feet, etc. from the EGM). In some embodiments, the inventive system of the present invention includes a contactless system/method, where the contactless system/method includes receiving information from the user's contactless card, where the contactless card may be present (e.g., held by a magnetic force) and/or in contact with the exemplary inventive auxiliary electronic device (e.g., tablet), where the sufficient proximity of the user can be indicative of the user's presence in front of the EGM. In some embodiments, the inventive system (including, e.g., the exemplary inventive auxiliary electronic device) can be configured to identify and/or read a user's mobile phone, where the inventive system can be configured to process the user's mobile phone as a “player card”, where the player card can use RFID and/or Bluetooth (BT) to provide access/log in and/or maintain a user's access to the EGM while the user is in a sufficient proximity to the EGM.

In some embodiments, the inventive system(s) of the present invention can use EGM(s), where the EGM provides connectivity (e.g., direct connectivity) through at least one standardized port (e.g., RS232 and/or USB) for the purpose of connecting, by use of an exemplary inventive auxiliary smart electronic device (e.g., tablet), to a Central Monitoring and/or Control System (e.g., server) of the present invention. In some embodiments, the inventive system(s) of the present invention can use an exemplary inventive auxiliary smart electronic device (e.g., tablet), where the exemplary inventive auxiliary smart electronic device provides connectivity (e.g., direct connectivity) through at least one standardized port (e.g., RS232 and/or USB) for the purpose of connecting, by use of an EGM, to a Central Monitoring and/or Control System (e.g., server) of the present invention. In some embodiments of the inventive system(s) of the present invention, the EGM and the exemplary inventive auxiliary smart electronic device can be directly connected through at least one standardized port (e.g., RS232 and/or USB). In some embodiments of the inventive system(s) of the present invention, the EGM and the exemplary inventive auxiliary smart electronic device are not directly connected through at least one standardized port (e.g., RS232 and/or USB).

In some embodiments, the inventive system(s) include the use of an exemplary inventive auxiliary smart electronic device (e.g., a tablet), where the exemplary inventive auxiliary electronic device can be configured to provide a card reading service(s) not previously available to the user (i.e., prior to the installation of the tablet) on an EGM. In some embodiments, the inventive system can provide a user with additional services by use of a personal account card and an online connection (i.e., the connection established between the exemplary inventive auxiliary electronic device (e.g., a tablet) and a server). In some embodiments, additional services can include, but are not limited to: access/login to an account(s) and/or accepting a user's input (e.g., where the input reflects the user's credentials and/or profile), transfer credits to and/or from the EGM using the Electronic Fund Transfer (EFT) and Advanced Fund Transfer (AFT) command of the protocols (e.g., SAS 6.01 and 6.02), or any other card-related service(s).

In some embodiments, the inventive system(s) of the present invention(s) can include utilizing an exemplary inventive auxiliary smart electronic device (e.g., tablet), (e.g., where a tablet is installed at, for example but not limited to, the right/left side of a user operated EGM, and is affixed in a portrait/length-wise orientation to reduce obstruction as compared to being affixed in a landscape orientation, e.g., so as to maximize space/area between the subject EGM and an adjacent machine). In some embodiments, the exemplary inventive auxiliary electronic device (e.g., tablet) can be configured to receive power from the EGM and/or can communicate with the EGM, an internet, an intranet, a user, or any combination thereof.

In some embodiments, the inventive system(s) of the present invention is/are configured to provide at least one additional service to a user. In some embodiments, an additional service(s) can be provided with or without an application (e.g., a main game application, an application/game activated by a user) of the EGM. In some embodiments, the exemplary inventive auxiliary electronic device (e.g., a tablet) can be configured to connect (e.g., online via internet and/or intranet) to the Central Monitoring System, third party servers, the internet by, e.g., a WiFi connection, or any combination thereof.

In some embodiments, the inventive system(s) of the present invention can be configured to provide at least one additional service to a user, including, but not limited to: responsible gaming (e.g., set a limit on a user playing activity and verify that the limit(s) is/are satisfied/met), player tracking and loyalty (e.g., track user usage and/or habits and provide the user with awards and/or bonus schemes, and propose/advertise for products and services consistent with the user's activity history), multimedia and added value services (e.g., provide info-entertainment content to a user in a multimedia format; provide to the user access to additional services (e.g., Sports/Theater/Hotel/Restaurant booking, Food and Drink order/delivery, etc.)), side games (e.g., provide to the user an ability/choice to participate/join in various games such as, e.g., number games (e.g., Keno, Lotto, Pick 3-4-5, Powerball etc.) and/or electronic scratch, transfer to and/or from the EGM a user's credits obtained from a user's personal account for participating in all related services mentioned, where the transfer can be provided by the use of the Electronic Fund Transfer (EFT) and/or Advanced Fund Transfer (AFT) command(s) of protocols, (e.g., SAS 6.01 and 6.02).

In some embodiments of the inventive system(s) of the present invention, the inventive system can be configured to deliver/receive information by use of an exemplary inventive auxiliary smart electronic device (e.g., a tablet), where the exemplary inventive auxiliary electronic device can be configured to receive information from a card reader and/or include card reading capabilities (e.g., the card reader module can be part of the tablet). In some embodiments, the exemplary inventive auxiliary smart electronic device (e.g., a tablet) can be configured to read cards (i.e., card reading capabilities), where the inventive system allows the user to access/log into the user's personal account by use of the user's personal card and/or entering a password, where the user enters the password through a screen, e.g., a touchscreen, and where the password entry provides for verification. In some embodiments, the inventive system can include an additional module, where the additional module can include card reading capabilities (e.g., a card reading module), and can be attached to the exemplary inventive auxiliary electronic device (e.g., at the bottom, the top, or the side of the module) so as to present to the user a combined/augmented machine, forming one unit, which provides the user with one machine including the exemplary inventive auxiliary electronic device (e.g., a tablet), where the exemplary inventive auxiliary electronic device can be configured to include card reading capabilities and/or receive information from a card reader. In some embodiments, the exemplary inventive auxiliary electronic device (e.g., a tablet including card reading capabilities) can be mounted onto the EGM, where the mounting can be a metal bracket (e.g., on the machine cabinet side and support the tablet on the opposite side), where the metal bracket can incline the tablet such that the angle can be ergonomically accessible to a user (e.g., card insertion and/or card removal). In some embodiments, an exemplary inventive auxiliary smart electronic device (e.g., a tablet) can be sufficiently secured (e.g., by a metal bracket) such that it can sufficiently reduce theft and/or sufficiently increase security. In some embodiments, an exemplary inventive auxiliary smart electronic device (e.g., a tablet) attached to an EGM can include a card holder for the card (e.g., a slot) to be present/confined in/to the card reader for the duration of time that the user is in sufficient proximity of the EGM/tablet (e.g., 0.5 feet, 1 foot, 2 feet distance between a user and the EGM/tablet), and where the inventive system can be configured to identify the presence and/or absence of the user as noted by the presence of the user's personal card. In some embodiments, when a positive identification of user presence is generated by the inventive system, any games/activities initiated by the user is/are maintained. In some embodiments, when a negative identification of user presence is generated by the inventive system, any games/activities initiated by the user is/are terminated.

In some embodiments of the inventive system(s) of the present invention, an exemplary inventive auxiliary smart electronic device (e.g., a tablet) attached to an EGM can identify a user by magnetic and/or smart technology. In some embodiments, the inventive system can be configured to deliver/receive information from an exemplary inventive auxiliary smart electronic device (e.g., a tablet), where the exemplary inventive auxiliary smart electronic device can include an integrated NFC/RFID reader(s). In some embodiments, the exemplary inventive auxiliary smart electronic device can be configured to identify and/or process contactless player cards, where the exemplary inventive auxiliary smart electronic device can be configured to permit a user to access/login to the user's personal account after a user's identification is verified. In some embodiments, the access/login can be initiated/continued when the inventive system recognizes a user's personal card when a user places/taps/contacts the personal card on the exemplary inventive auxiliary smart electronic device (e.g., the inventive system identifies the personal card once the user places the card flat and parallel to the exemplary inventive auxiliary smart electronic device's screen). In some embodiments, the inventive system can be configured receive a password input from a user and verify/not verify the password to permit access/login to the user. In some embodiments, the inventive system can be configured to become activated by a user when a user presents a contactless card, and the user's card may remain attached on the exemplary inventive auxiliary smart electronic device's screen surface, where the attachment can be reversible (e.g., a magnetic attachment), where the attachment provides verification that the user is present within a sufficient proximity in front of the machine (e.g., but not limited to, 0.5 feet, 1.0 feet, 2.0 feet, etc.) and provide continued access of the services of the inventive system to the user. In some embodiments, the present invention minimizes or prevents a scenario when the user's session remains open/accessible after the user has left the machine (e.g., the user has not logged out), and another individual could view the user's personal data and/or continue using the user's account (e.g., another individual may cash out at least a portion or all (e.g., 0.1%-100%) of the user's winnings).

In some embodiments, the inventive system(s) of the present invention can be configured to receive and verify information (e.g., a personal player card) from a user's mobile phone/personal tablet/personal smart device, where the mobile phone/personal tablet/personal smart device can be configured to support and utilize NFC/RFID and BT transceiver modules, where the mobile phone/personal tablet/personal smart device can activate the inventive system when a user initiates access to the EGM by using a personal player card, where the inventive system can be configured to provide the user with additional services and/or convenience. In an embodiment, for example, the inventive system can be configured to recognize the use of a mobile phone in conjunction with the tablet by receiving the user's sign-in information using the NFC/RFID transceiver. In some embodiments, the inventive system(s) can be configured to permit a user access without requiring the user to enter a PIN (i.e., due to the NFC security), and the inventive system can be configured to generate/establish a BT connection between the tablet and the mobile phone of the user, which can provide a larger radius to the user to permit increased movement/convenience and/or sufficiently increased distance between the EGM and the user such that the user can maintain access without contacting the user's mobile phone with a card reader or the fixed tablet. In some embodiments, as soon as the user leaves his position (i.e., increases the distance between the user and the EGM/tablet/VLT) in front of the EGM, the inventive system can be configured to trace the signal strength and will sign-out the user automatically when the signal level drops below certain limits (e.g., as provided by the tablet through the BT connection). In some embodiments, the user's personal data can be sufficiently protected from third parties (e.g., as previously described by configuring the inventive system to automatically sign out/log off/terminate session). In some embodiments, the inventive system can be configured to automatically log-out/sign-in the user to a nearby EGM by the use of, e.g., the BT 4.0 (BLE) standard and/or WiFi network(s).

Illustrative Operating Environments

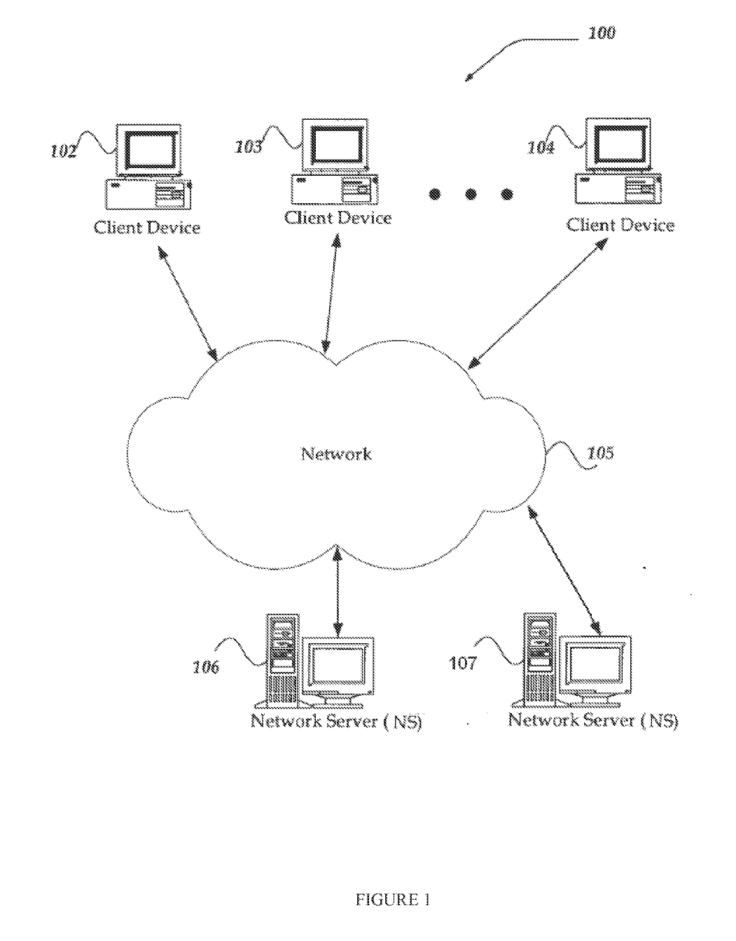

FIG. 1 illustrates one embodiment of an environment in which the present invention may operate. However, not all of these components may be required to practice the invention, and variations in the arrangement and type of the components may be made without departing from the spirit or scope of the invention. In some embodiments, the inventive system and method may include a large number of members and/or concurrent transactions. In other embodiments, the inventive system and method are based on a scalable computer and network architecture that incorporates varies strategies for assessing the data, caching, searching, and database connection pooling. An example of the scalable architecture is an architecture that is capable of operating multiple servers.

In embodiments, members of the computer system 102-104 include virtually any computing device capable of receiving and sending a message over a network, such as network 105, to and from another computing device, such as servers 106 and 107, each other, and the like. In embodiments, the set of such devices includes devices that typically connect using a wired communications medium such as personal computers, multiprocessor systems, microprocessor-based or programmable consumer electronics, network PCs, and the like. In embodiments, the set of such devices also includes devices that typically connect using a wireless communications medium such as cell phones, smart phones, pagers, walkie talkies, radio frequency (RF) devices, infrared (IR) devices, CBs, integrated devices combining one or more of the preceding devices, or virtually any mobile device, and the like. Similarly, in embodiments, client devices 102-104 are any device that is capable of connecting using a wired or wireless communication medium such as a PDA, POCKET PC, wearable computer, and any other device that is equipped to communicate over a wired and/or wireless communication medium.

In embodiments, each member device within member devices 102-104 may include a browser application that is configured to receive and to send web pages, and the like. In embodiments, the browser application may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In embodiments, programming may include either Java, .Net, QT, C, C++ or other suitable programming language.

In embodiments, member devices 102-104 may be further configured to receive a message from another computing device employing another mechanism, including, but not limited to email, Short Message Service (SMS), Multimedia Message Service (MMS), instant messaging (IM), internet relay chat (IRC), mIRC, Jabber, and the like or a Proprietary protocol.

In embodiments, network 105 may be configured to couple one computing device to another computing device to enable them to communicate. In some embodiments, network 105 may be enabled to employ any form of computer readable media for communicating information from one electronic device to another. Also, in embodiments, network 105 may include a wireless interface, and/or a wired interface, such as the Internet, in addition to local area networks (LANs), wide area networks (WANs), direct connections, such as through a universal serial bus (USB) port, other forms of computer-readable media, or any combination thereof. In embodiments, on an interconnected set of LANs, including those based on differing architectures and protocols, a router may act as a link between LANs, enabling messages to be sent from one to another.

Also, in some embodiments, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, in some embodiments, remote computers and other related electronic devices could be remotely connected to either LANs or WANs via a modem and temporary telephone link. In essence, in some embodiments, network 105 includes any communication method by which information may travel between client devices 102-104, and servers 106 and 107.

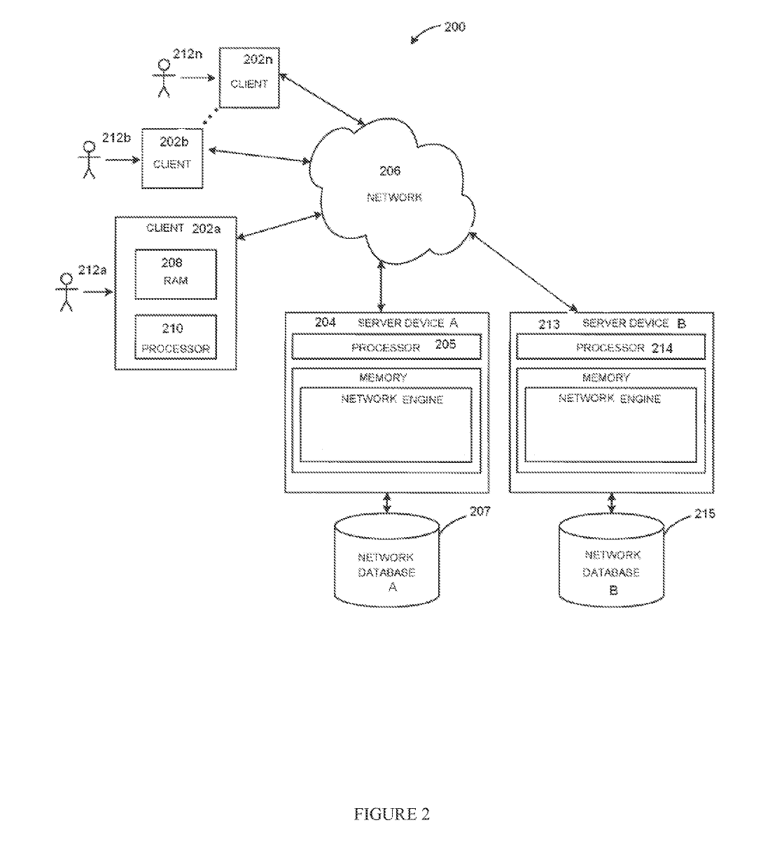

FIG. 2 shows another exemplary embodiment of the computer and network architecture that supports the methods and systems of the instant invention. In some embodiments, the member devices 202a, 202b thru 202n shown each at least includes a computer-readable medium, such as a random access memory (RAM) 208 coupled to a processor 210 or FLASH memory. In some embodiments, the processor 210 may execute computer-executable program instructions stored in memory 208. In some embodiments, such processors comprise a microprocessor, an ASIC, and state machines. In some embodiments, such processors comprise, or may be in communication with, media, for example computer-readable media, which stores instructions that, when executed by the processor, cause the processor to perform the steps described herein. Embodiments of computer-readable media may include, but are not limited to, an electronic, optical, magnetic, or other storage or transmission device capable of providing a processor, such as the processor 210 of client 202a, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, and JavaScript.

In some embodiments, member devices 202a-n may also comprise a number of external or internal devices such as a mouse, a CD-ROM, DVD, a keyboard, a display, or other input or output devices. Examples of client devices 202a-n may be personal computers, digital assistants, personal digital assistants, cellular phones, mobile phones, smart phones, pagers, digital tablets, laptop computers, Internet appliances, and other processor-based devices. In general, a client device 202a may be any type of processor-based platform that is connected to a network 206 and that interacts with one or more application programs. Client devices 202a-n may operate on any operating system capable of supporting a browser or browser-enabled application, such as Microsoft™, Windows™, or Linux. The client devices 202a-n shown may include, for example, personal computers executing a browser application program such as Microsoft Corporation's Internet Explorer™, Apple Computer, Inc.'s Safari™, Mozilla Firefox, and Opera. Through the client devices 202a-n, users, 212a-n communicate over the network 206 with each other and with other systems and devices coupled to the network 206. As shown in FIG. 2, server devices 204 and 213 may be also coupled to the network 206. In an embodiment of the present invention, one or more clients can be a mobile client.

In some embodiments, the term “mobile electronic device” may refer to any portable electronic device that may or may not be enabled with location tracking functionality. For example, a mobile electronic device can include, but is not limited to, a mobile phone, Personal Digital Assistant (PDA), Blackberry™, Pager, Smartphone, or any other reasonable mobile electronic device. For ease, at times the above variations are not listed or are only partially listed, this is in no way meant to be a limitation.

In some embodiments, the terms “proximity detection,” “locating,” “location data,” “location information,” and “location tracking” as used herein may refer to any form of location tracking technology or locating method that can be used to provide a location of a mobile electronic device, such as, but not limited to, at least one of location information manually input by a user, such as, but not limited to entering the city, town, municipality, zip code, area code, cross streets, or by any other reasonable entry to determine a geographical area; Global Positions Systems (GPS); GPS accessed using Bluetooth™; GPS accessed using any reasonable form of wireless and/or non-wireless communication; WiFi™ server location data; Bluetooth™ based location data; triangulation such as, but not limited to, network based triangulation, WiFi™ server information based triangulation, Bluetooth™ server information based triangulation; Cell Identification based triangulation, Enhanced Cell Identification based triangulation, Uplink-Time difference of arrival (U-TDOA) based triangulation, Time of arrival (TOA) based triangulation, Angle of arrival (AOA) based triangulation; techniques and systems using a geographic coordinate system such as, but not limited to, longitudinal and latitudinal based, geodesic height based, cartesian coordinates based; Radio Frequency Identification such as, but not limited to, Long range RFID, Short range RFID; using any form of RFID tag such as, but not limited to active RFID tags, passive RFID tags, battery assisted passive RFID tags; or any other reasonable way to determine location. For ease, at times the above variations are not listed or are only partially listed, this is in no way meant to be a limitation.

In some embodiments, near-field wireless communication (NFC) can represent a short-range wireless communications technology in which NFC-enabled devices are “swiped,” “bumped,” “tap” or otherwise moved in close proximity to communicate. In some embodiments, NFC could include a set of short-range wireless technologies, typically requiring a distance of 10 cm or less.

In some embodiments, NFC may operate at 13.56 MHz on ISO/IEC 18000-3 air interface and at rates ranging from 106 kbit/s to 424 kbit/s. In some embodiments, NFC can involve an initiator and a target; the initiator actively generates an RF field that can power a passive target. In some embodiment, this can enable NFC targets to take very simple form factors such as tags, stickers, key fobs, or cards that do not require batteries. In some embodiments, NFC peer-to-peer communication can be conducted when a plurality of NFC-enable devices within close proximity of each other.

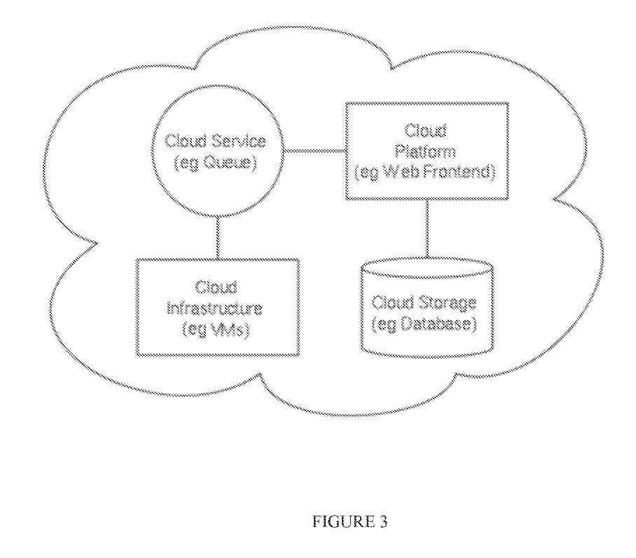

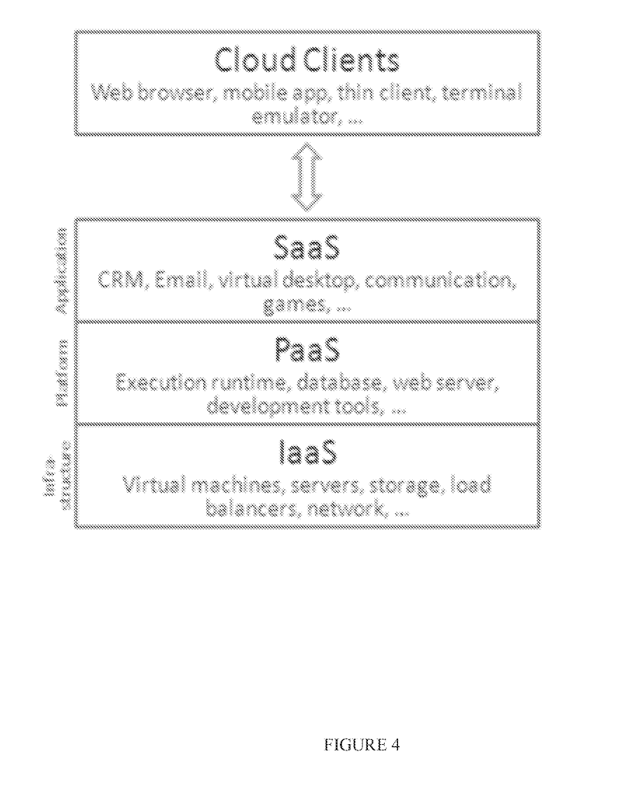

For purposes of the instant description, the terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user). In some embodiments, the instant invention offers/manages the cloud computing/architecture as, but not limiting to: infrastructure a service (IaaS), platform as a service (PaaS), and software as a service (SaaS). FIGS. 3 and 4 illustrate schematics of exemplary implementations of the cloud computing/architecture.

Of note, the embodiments described herein may, of course, be implemented using any appropriate computer system hardware and/or computer system software. In this regard, those of ordinary skill in the art are well versed in the type of computer hardware that may be used (e.g., a mainframe, a mini-computer, a personal computer (“PC”), a network (e.g., an intranet and/or the internet)), the type of computer programming techniques that may be used (e.g., object oriented programming), and the type of computer programming languages that may be used (e.g., C++, Basic, AJAX, Javascript). The aforementioned examples are, of course, illustrative and not restrictive.

In some embodiments, the present invention provides for a method, including: providing a first component comprising a first game-operating device, operationally interconnecting the first component to a second component to form a second game-operating device; where the first game-operating device is a stand-alone operating device, and where the second component is a dedicated auxiliary device, delivering from the second component at least one auxiliary service which has not been previously provided by the first component, where the at least one auxiliary service selected from the group including: a card reading service, an online connection service, a responsible gaming service, a player tracking and loyalty service, a multimedia service, a side game service, a user identification service, and an identity protection service. In some embodiments, the dedicated auxiliary device is affixed to the first game-operating device. In some embodiments, the dedicated auxiliary device is affixed to the first game-operating device in a vertical orientation. In some embodiments, the dedicated auxiliary device is affixed to the first game-operating device in a horizontal orientation.

In some embodiments, the present invention provides for a device, including: a first component, where the first component previously existed as a first game-operating device which has not been previously provided at least one auxiliary service selected from the group including: a card reading service, an online connection service, a responsible gaming service, a player tracking and loyalty service, a multimedia service, a side game service, a user identification service, and an identity protection service; where the first game-operating device is a stand-alone operating device, a second component which is a dedicated auxiliary device configured to provide the at least one auxiliary service in conjunction with the first game-operating device; and where the dedicated auxiliary device is operationally interconnected with the first game-operating device. In some embodiments, the dedicated auxiliary device is affixed to the first game-operating device. In some embodiments, the dedicated auxiliary device is affixed to the first game-operating device in a vertical orientation. In some embodiments, the dedicated auxiliary device is affixed to the first game-operating device in a horizontal orientation.

While a number of embodiments of the present invention have been described, it is understood that these embodiments are illustrative only, and not restrictive, and that many modifications may become apparent to those of ordinary skill in the art. Further still, the various steps may be carried out in any desired order (and any desired steps may be added and/or any desired steps may be eliminated).

What is claimed is:

1. A method, comprising:
providing a first component comprising a first game-operating device,
operationally interconnecting the first component to a second component to form a second game-operating device;
wherein the first game-operating device is a stand-alone operating device, and
wherein the second component is a dedicated auxiliary device,
delivering from the second component at least one auxiliary service which has not been previously provided by the first component,
wherein the at least one auxiliary service selected from the group consisting of:
(i) a card reading service,
(ii) an online connection service,
(iii) a responsible gaming service,
(iv) a player tracking and loyalty service,
(v) a multimedia service,
(vi) a side game service,
(vii) a user identification service, and
(viii) an identity protection service.

2. The method of claim 1, wherein the dedicated auxiliary device is affixed to the first game-operating device.

3. The method of claim 2, wherein the dedicated auxiliary device is affixed to the first game-operating device in a vertical orientation.

4. The method of claim 2, wherein the dedicated auxiliary device is affixed to the first game-operating device in a horizontal orientation.

5. A device, comprising:
a first component, wherein the first component previously existed as a first game-operating device which has not been previously provided at least one auxiliary service selected from the group consisting of:
(i) a card reading service,
(ii) an online connection service,
(iii) a responsible gaming service,
(iv) a player tracking and loyalty service,
(v) a multimedia service,
(vi) a side game service,
(vii) a user identification service, and
(viii) an identity protection service;
wherein the first game-operating device is a stand-alone operating device,
a second component which is a dedicated auxiliary device configured to provide the at least one auxiliary service in conjunction with the first game-operating device; and
wherein the dedicated auxiliary device is operationally interconnected with the first game-operating device.

6. The device of claim 5, wherein the dedicated auxiliary device is affixed to the first game-operating device.

7. The device of claim 6, wherein the dedicated auxiliary device is affixed to the first game-operating device in a vertical orientation.

8. The device of claim 6, wherein the dedicated auxiliary device is affixed to the first game-operating device in a horizontal orientation.
